(19) United States
(12) Patent Application Publication
(10) Pub. No.: US 2012/0216773 A1
(43) Pub. Date: Aug. 30, 2012

(54) INJECTION OF GASEOUS FUELS

(75) Inventors: Simon Christopher Brewster, Warwickshire (GB); Geoffrey Paul Cathcart, Mount Lawley (AU); Benjamin John Parry, Mullaloo (AU); Donald Andrew Railton, Duncraig (AU)

(73) Assignee: Orbital Australia Pty Ltd, Balcatta, Western Australia (AU)

(21) Appl. No.: 13/380,188

(22) PCT Filed: Jun. 30, 2010
(86) PCT No.: PCT/AU2010/000827

§ 371 Date: May 4, 2012

(30) Foreign Application Priority Data
Jun. 30, 2009 (AU) 2009903047

(51) Int. Cl. F02M 43/00

(52) U.S. Cl. 123/299

(57) ABSTRACT

A gaseous fuel injection system (10) for delivering metered amounts of gaseous fuel into the combustion chamber of an engine, and also a method for injecting gaseous fuel directly into a combustion chamber of an internal combustion engine. The gaseous fuel injection system (10) comprises a body structure (11) defining a holding chamber (13) from which a fluid mixture contained therein can be subsequently delivered by a delivery injector (15) into the combustion chamber. The delivery injector (15) has an inlet (16) communicating with the holding chamber (13) and an outlet (18) for communication with the combustion chamber. The holding chamber (13) is adapted to receive a quantity of gaseous fuel from a fuel source through an inlet port (17). The holding chamber (13) is also adapted to receive a metered quantity of a supplementary gaseous fluid through a metering means (21). In one arrangement, the supplementary gaseous fluid may function as a diluent for the gaseous fuel. When functioning as a diluent, the supplementary gaseous fluid may comprise an inactive gas which merely contributes volume to the mixture and performs no active function, or alternatively may perform an active function within the mixture, as for example, an oxidant. The gaseous fuel incorporated in the injected mixture may comprise the sole fuel requirement for the combustion process. Alternatively, the gaseous fuel incorporated in the injected mixture may augment, or be augmented by, another fuel delivered into the combustion chamber for the combustion process.

### FIELD OF THE INVENTION

The present invention relates to injection of fuels in internal combustion engines. The invention is concerned particularly with direct injection of gaseous fuels.

The term “direct injection” refers to delivery of fuel directly into the combustion chambers of internal combustion engines, typically by way of fuel or delivery injectors.

The term “gaseous fuels” as used herein refers to compressed gas fuels such as compressed natural gas (CNG) and hydrogen (H₂), and liquefied gaseous fuels such as liquefied petroleum gas (LPG) and liquefied natural gas (LNG).

### BACKGROUND ART

The following discussion of the background art is intended to facilitate an understanding of the present invention only. The discussion is not an acknowledgement or admission that any of the material referred to is or was part of the common general knowledge as at the priority date of the application.

There exist many potential advantages in using gaseous fuels in engines in place of, or together with, the more commonly used liquid fuels. For example, it is well appreciated that the undesirable exhaust emissions from an engine using a gaseous fuel can be lower than for a comparable engine using liquid fuel. Further, the use of gaseous fuels can in certain cases translate to a significant cost saving for the user due to the per litre cost thereof as compared to the per litre cost of the more commonly used liquid fuels.

Further, there may also exist certain potential advantages of having a system which can inject gaseous fuel directly into the combustion chambers of the engine. As well as potentially leading to simpler systems requiring less mechanical components and facilitating improved metering control of the gaseous fuel to the engine as compared with prior art systems, such systems are likely to enable certain cost and performance benefits to be realised by users.

In such systems, the gaseous fuel is injected into a combustion chamber of the engine through a fuel or delivery injector which delivers a metered quantity of the fuel directly into the combustion chamber. Operation of the fuel injector is controlled by a control means such as an electronic control unit (ECU). The ECU determines the parameters by which the fuel injector operates. In particular, the ECU can control the duration of the opening of the fuel injector, the time at which the fuel injector begins to open relative to the engine operating cycle, and the time at which the fuel injector begins to close relative to the engine operating cycle. The electronic control unit obtains input signals from various sensors providing information on the operating conditions of the engine as well as the driver demands, and outputs control signals to certain engine components.

Fuelling requirements for the engine vary according to engine parameters, driver demand parameters and supply characteristics of the fuel (such as pressure and composition). Accordingly, the fuelling requirements can vary between a high demand condition such as at a full engine load, and a low demand condition such as at engine idle.

Direct injection of gaseous fuel does however present a number of challenges.

One such challenge is the need to accommodate the wide range of fuelling requirements typically required by an engine. The relationship between the maximum fuel quantity and the minimum fuel quantity that can be delivered reliably by a fuel or delivery injector can often be difficult to achieve. A fuel injector configured to reliably accommodate fuelling requirements for a high fuel demand condition can encounter difficulties in reliably accommodating fuelling requirements for a low fuel demand condition, and vice versa.

It is against this background that the present invention was developed.

### DISCLOSURE OF THE INVENTION

The present invention stems from the realisation that mixing a gaseous fuel with a supplementary gaseous fluid prior to direct injection of the gaseous fuel into a combustion chamber can deliver certain advantages.

According to a first aspect of the invention there is provided a method for injecting gaseous fuel directly into a combustion chamber of an internal combustion engine, the method comprising providing a supply of gaseous fuel, delivering a metered quantity of a supplementary gaseous fluid to the gaseous fuel to form a fluid mixture, and injecting a metered quantity of the fluid mixture into the combustion chamber.

Delivery of the supplementary gaseous fluid to the gaseous fuel serves to increase the quantity (bulk) of the fluid mixture, which may facilitate metering accuracy of the injected fluid mixture.

In one arrangement, the supplementary gaseous fluid may function as a diluent for the gaseous fuel. With this arrangement, the quantity of gaseous fuel delivered in the injection event would not vary, but the overall quantity of fluid delivered during the injection event does increase (by virtue of the presence of the supplementary gaseous fluid mixed with the gaseous fuel). The increased overall quantity of fluid delivered during the injection event is advantageous for low fuel demand conditions as it increases the amount of fluid to be delivered by the injector, and hence metering accuracy and the reliability of the injection process.

When functioning as a diluent, the gaseous fluid may take any appropriate form. The gaseous fluid may comprise an inactive gas which merely contributes volume to the mixture and performs no active function; for example, carbon dioxide or an inert gas. Alternatively, the gaseous fluid may perform an active function within the mixture; for example, functioning as an oxidant such as air.

The scenario involving the injected mixture comprising the gaseous fuel and an oxidant may be advantageous for certain applications as it can facilitate the delivery of an ignitable mixture to initiate the combustion process within the combustion chamber. Typically, the injected ignitable mixture would be delivered as a fuel cloud at or adjacent the ignition point within the combustion chamber.

The gaseous fuel incorporated in the injected mixture may comprise the sole fuel requirement for the combustion process.

Alternatively, the gaseous fuel incorporated in the injected mixture may augment, or be augmented by, another fuel delivered into the combustion chamber for the combustion process. The other fuel may be a gaseous fuel or a liquid fuel. Where the other fuel is a gaseous fuel, it may be the same type of fuel as the gaseous fuel in the injected mixture; for example, both the gaseous fuel incorporated in the injected mixture and the other fuel may comprise compressed natural gas.

The other fuel may be delivered into the combustion chamber in any appropriate way; for example, the other fuel may be delivered by way of direct injection or port injection.

In one arrangement, the other fuel may comprise a liquid fuel and it may be delivered into the combustion chamber in the same injection event as the gaseous mixture.

The invention may thus provide an arrangement in which there is mixing of two gaseous fluids, one of which may be a fuel, before a further subsequent injection into an engine (which may or may not be combined with liquid fuel injection).

According to a second aspect of the invention there is provided a method for fuelling a combustion chamber comprising delivering a first fuel and a second fuel to a combustion chamber of an internal combustion engine, the first fuel comprising a gaseous fuel contained in a fluid mixture injected directly into the combustion chamber.

Preferably, the fluid mixture is formed by providing a supply of the gaseous fuel and delivering a metered quantity of a supplementary gaseous fluid to the gaseous fuel.

The second fuel may be delivered into the combustion chamber in any appropriate way; for example, the second fuel may be delivered by way of direct injection or port injection.

The fluid mixture may comprise a mixture of the first fuel and an oxidant such as air. In this way, the fluid mixture may comprise an ignitable mixture.

The second fuel may mix with combustion air delivered to the combustion chamber to provide a bulk lean mixture within the combustion chamber. With this arrangement, the second fuel may be delivered through port injection.

The arrangement where the fluid mixture containing the gaseous fuel comprises an ignitable mixture and the second fuel mixes with combustion air delivered into the combustion chamber to provide a bulk lean mixture is advantageous as it provides a stratified charge with the combustion chamber.

According to a third aspect of the invention there is provided a direct injection fuel system for an engine, the injection system comprising a holding chamber, means for providing a supply of gaseous fuel, means for delivering a metered quantity of a supplementary gaseous fluid to the gaseous fuel to form a fluid mixture, and means for injecting a metered quantity of the fluid mixture into a combustion chamber of the engine.

According to a fourth aspect of the invention there is provided a direct injection fuel system for an engine, the injection system comprising a holding chamber, means for providing a supply of gaseous fuel to the holding chamber, means for delivering a metered quantity of a supplementary gaseous fluid to the holding chamber, and means for injecting a metered quantity of the contents of the holding chamber into a combustion chamber of the engine.

The fuel injection system may further comprise means for delivering a metered quantity of a liquid fuel to the holding chamber.

According to a fifth aspect of the invention there is provided a direct injection fuel system for an engine, the injection system comprising means for delivering a metered quantity of a gaseous fluid mixture comprising a first fuel and a supplementary gas to a combustion chamber, the first fuel comprising a gaseous fuel, and means for delivering a second fuel to the combustion chamber.

According to a sixth aspect of the invention there is provided an engine having a fuel injection system according to the third, fourth or fifth aspect of the invention.

### BRIEF DESCRIPTION OF THE DRAWINGS

The invention will be better understood by reference to the following description of several specific embodiments as shown in the accompanying drawings in which:

FIG. 1 is a schematic view of an injection system according to a first embodiment;

FIG. 2 is a schematic view of an injection system according to a second embodiment;

FIG. 3 is a schematic view of an injection system according to a third embodiment; and

FIG. 4 is a schematic view of an injection system according to a fourth embodiment.

### BEST MODE(S) FOR CARRYING OUT THE INVENTION

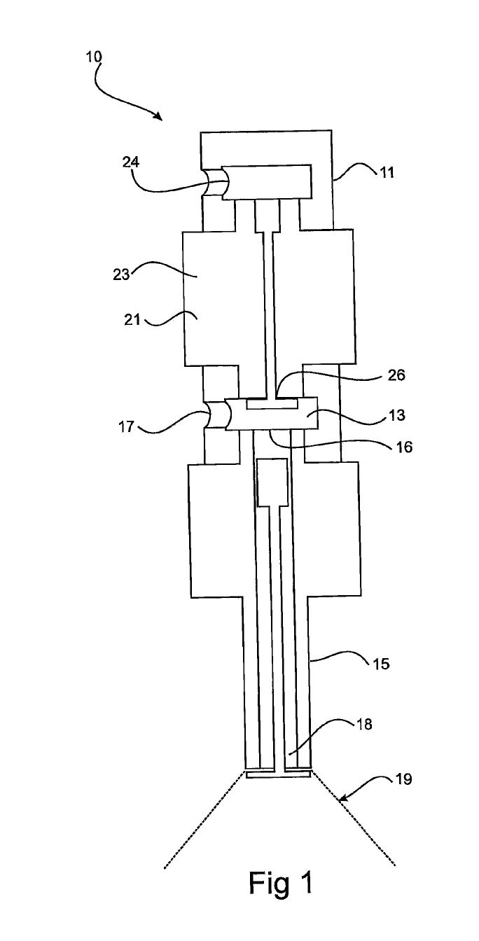

The first embodiment, which is shown in FIG. 1, is directed to a gaseous fuel injection system 10 for delivering metered amounts of gaseous fuel into the combustion chamber or cylinder of an engine.

The gaseous fuel injection system 10 comprises a body structure 11 defining a holding chamber 13 from which a fluid mixture contained therein can be subsequently delivered by a delivery injector 15 into a combustion chamber (not shown) of the engine. In the arrangement shown, the delivery injector 15 is of the outwardly opening poppet-type which is effectively self-sealing by virtue of combustion gases acting thereon when the injector 15 is closed, although of course other injector configurations may be employed. The delivery injector 15 has an inlet 16 communicating with the holding chamber 13 and an outlet 18 for communication with the combustion chamber. In FIG. 1, the fluid mixture is delivered as a spray which is depicted schematically by lines identified by reference numeral 19.

Operation of the delivery injector 15 is controlled by a control means such as an ECU (not shown). The ECU determines the parameters by which the delivery injector 15 operates and the operation of the delivery injector 15 determines the quantity of the fluid mixture which is delivered during a direct injection event. In particular, the ECU can control the duration of the opening of the delivery injector 15, the time at which the delivery injector 15 begins to open relative to the engine operating cycle, and the time at which the delivery injector 15 begins to close relative to the engine operating cycle. The ECU obtains input signals from various sensors providing information on the operating conditions of the engine as well as the driver demands, and outputs control signals to certain engine components.

The holding chamber 13 is adapted to receive a quantity of gaseous fuel from a fuel source (not shown) through an inlet port 17. Typically, the inlet port 17 would communicate with a supply line leading from a fuel tank containing the gaseous fuel. The supply line may also incorporate a regulator for regulating the supply pressure to the holding chamber 13. In certain applications the vapour pressure of the gaseous fuel may be utilised as the supply pressure for delivery of the gaseous fuel to the holding chamber 13, while in other applications there may be a delivery pump associated with the supply line for delivering the gaseous fuel to the holding chamber 13.

The holding chamber 13 is also adapted to receive a metered quantity of supplementary gas from a metering means 21.

In this embodiment, the supplementary gas comprises air which mixes with the gaseous fluid in the holding chamber 13 to provide an ignitable mixture for delivery to the combustion chamber, as will be explained in more detail later. Accordingly, the holding chamber 13 functions as a mixing chamber.

In the arrangement shown, the metering means 21 comprises a calibrated metering injector 23 of the outwardly opening poppet-type. The metering injector 23 has an inlet 24 for communication with an air supply line (not shown) and an outlet 26 communicating with the holding chamber 13.

The holding chamber 13 is disposed between the metering injector 23 and the delivery injector 15. The holding chamber 13 may incorporate means (not shown) for releasing pressure therein in the event of ignition of the ignitable mixture contained therein.

The operation of the metering injector 23 is also controlled by the ECU. The ECU determines the parameters by which the metering injector 23 operates, and the operation of the metering injector 23 determines the quantity of the air which is delivered into the holding chamber 13 during a metering event.

The metering event to introduce air into the holding chamber 13 for mixing with gaseous fuel contained therein to form the ignitable mixture, and the injection event to deliver the ignitable mixture contained within the holding chamber 13, are separate events. More particularly, the injection event occurs subsequent to the metering event.

With this arrangement, operation of the delivery injector 15 can be retained within the dynamic range in which it provides reliable injection. This is because the injected mixture comprises the necessary amount of fuel required to meet the engine demand supplemented by a metered amount of air to the extent necessary to form an overall volume that can be delivered within the operating range of the delivery injector 15 for reliable injection. This facilitates metering accuracy.

Specifically, in circumstances of low fuel demand, the addition of the air to the quantity of gaseous fuel required to meet the demand has the effect of increasing the overall amount of fluid to be delivered by the delivery injector 15, and hence metering accuracy of the delivered fluid and the reliability of the injection process. This greatly assists the turn-down ratio of the delivery injector 15, so increasing the reliability of the injection process.

It is advantageous that the supplementary gas comprises air, and that the resultant mixture be an ignitable mixture. This typically requires that the mixture be stoichiometric or close to stoichiometric. The ignitable mixture can be utilised to initiate the combustion process within the combustion chamber, typically by delivering the ignitable mixture as a fuel cloud at or adjacent an ignition plug suitably arranged within the combustion chamber.

Because the mixture of gaseous fuel and air constitutes an ignitable mixture, it can be injected into the combustion chamber later in the compression stroke of the engine cycle. This is because early injection is not required in order to achieve adequate mixing with bulk air contained in the combustion chamber to facilitate combustion.

The gaseous fuel incorporated in the ignitable mixture may comprise the sole fuel requirement for the combustion process.

Alternatively, the gaseous fuel incorporated in the ignitable mixture may constitute a first fuel which augments, or is augmented by, a second fuel delivered into the combustion chamber for the combustion process. The second fuel may be a gaseous fuel or a liquid fuel. Where the second fuel is a gaseous fuel, it may be the same type of fuel as the first fuel; for example, both the first and second fuels may comprise compressed natural gas or hydrogen.

The second fuel may be delivered into the combustion chamber in any appropriate way; for example, the second fuel may be delivered by way of direct injection or port injection.

The second fuel may mix with bulk combustion air delivered to the combustion chamber through one or more inlet ports to provide a bulk lean mixture within the combustion chamber. With this arrangement, the second fuel would typically be delivered through port injection.

The arrangement where the first fuel comprises an ignitable mixture and the second fuel mixes with combustion air delivered to the combustion chamber to provide a bulk lean mixture is advantageous in certain applications as it provides a stratified charge within the combustion chamber.

In a low fuelling requirement condition, such as at engine idle or other low engine demand conditions, the supplementary air that mixes with the first fuel to provide the ignitable mixture may constitute the entire combustion air requirement for the combustion process.

In a high fuelling requirement condition, such as at full engine load, the supplementary air that mixes with the first fuel to provide the ignitable mixture may constitute a minor proportion of the combustion air requirement for the combustion process. In such a case, the major proportion of the combustion air requirement for the combustion process would be constituted by bulk air delivered into the combustion chamber through one or more inlet ports.

For intermediate fuelling requirement conditions, the proportion of combustion air required as bulk air delivered through one or more inlet ports may progressively increase with increasing fuel demand.

By way of example only, it is anticipated that at a high fuelling requirement condition, such as at full engine load, the supplementary air that mixes with the first fuel to provide the ignitable mixture may constitute less than about 10 per cent of the combustion air requirement for the combustion process. Further, it is anticipated that the supplementary air that mixes with the first fuel to provide the ignitable mixture may generally constitute less than about 50 per cent of the combustion air requirement for the combustion process.

The fuel injection system 10 according to the first embodiment can be controlled by the ECU to operate in various modes. In a first mode, the fuel injection system 10 may deliver only gaseous fuel to the combustion chamber; that is, the gaseous fuel is delivered without being supplemented with air in the holding chamber 13. In a second mode, the fuel injection system 10 may deliver a mixture of gaseous fuel and air as an ignitable mixture into the combustion chamber.

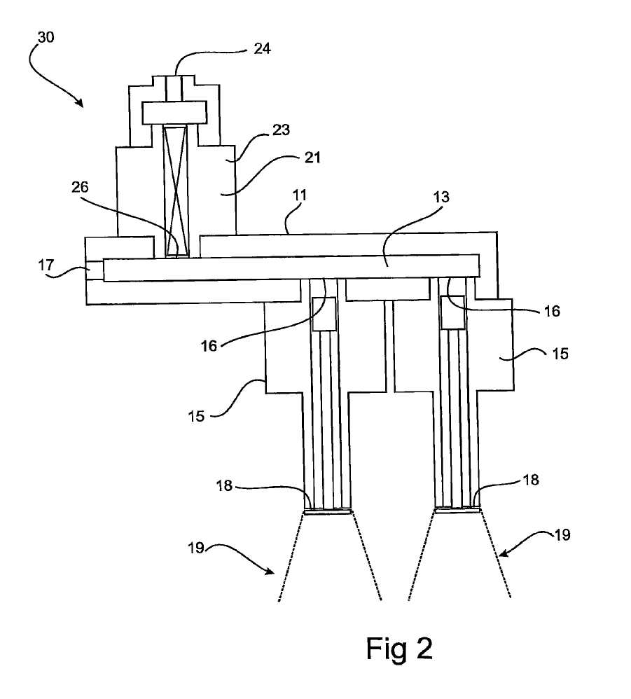

The second embodiment, which is shown in FIG. 2, is directed to a gaseous fuel injection system 30 for delivering metered amounts of gaseous fuel into the combustion chambers of a multi-cylinder internal combustion engine. The fuel injection system 30 according to the second embodiment is similar to the injection system 10 according to the first embodiment and the same reference numerals are used to identify corresponding parts. In the arrangement shown, there are two delivery injectors 15 for delivery of metered quantities of the fluid mixture into two combustion chambers. It will, of course, be understood that the injection system 30 may be configured to incorporate more than two delivery injectors 15 for delivery of gaseous fuel into respective combustion chambers of a multi-cylinder internal combustion engine.

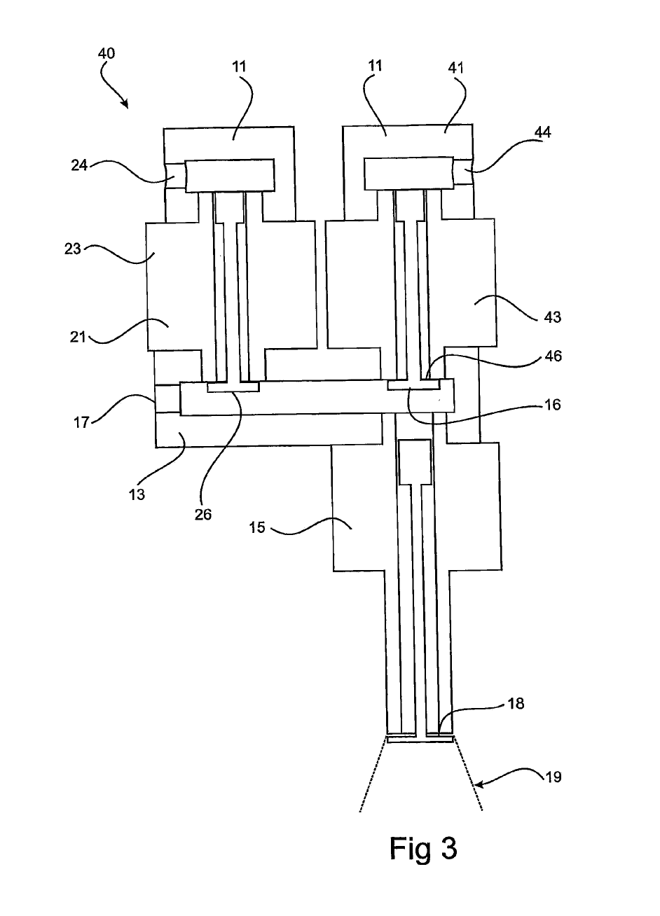

The third embodiment, which is shown in FIG. 3, is directed to a gaseous fuel injection system 40 for operation of an engine with dual fuels, one being a gaseous fuel and the other a liquid fuel. The liquid fuel may be of any appropriate type, although it is anticipated that the injection system 40 according to the embodiment is likely to be particularly suitable for ethanol and liquid fuel mixtures containing ethanol.

The fuel injection system 40 according to the third embodiment is similar to the injection system 10 according to the first embodiment and the same reference numerals are used to identify corresponding parts.

In addition to receiving the gaseous fuel through the gaseous fuel inlet port 17 as described in the first embodiment, the holding chamber 13 is also adapted to receive a quantity of the liquid fuel. Specifically, the holding chamber 13 is adapted to receive the liquid fuel through a metering means 41. In the arrangement shown, the metering means 41 comprises a calibrated metering injector 43 of the outwardly opening poppet-type. The metering injector 43 has an inlet 44 for communication with a liquid fuel supply line (not shown) and an outlet 46 communicating with the holding chamber 13.

The operation of the metering injector 43 is also controlled by the ECU. The ECU determines the parameters by which the metering injector 43 operates. The operation of the metering injector 43 determines the quantity of liquid fuel which is delivered into the holding chamber 13 during a metering event.

The fuel injection system 40 according to the third embodiment can be controlled by the ECU to operate in various modes. In a first mode, the fuel injection system 40 may deliver only gaseous fuel to the combustion chamber; that is, the gaseous fuel is delivered without being supplemented with air in the holding chamber 13. In a second mode, the fuel injection system 40 may deliver a mixture of gaseous fuel and air as an ignitable mixture into the combustion chamber. In a third mode, the fuel injection system 40 may deliver only liquid fuel to the combustion chamber; that is, the liquid fuel is delivered without delivery of air in the holding chamber 13. In a fourth mode, the fuel injection system 40 can deliver liquid fuel with the assistance of air delivered into the holding chamber 13. The fourth mode may be configured to constitute an air-assist fuel delivery process or a pulsed air assist delivery process. In a fifth mode, which is a variation of the fourth mode, the fuel injection system 40 can deliver liquid fuel with the assistance of gaseous fuel delivered into the holding chamber 13. In the fifth mode of operation, the delivery assistance to the liquid fluid is provided not by air (as is the case with the fourth mode) but rather by the gaseous fuel.

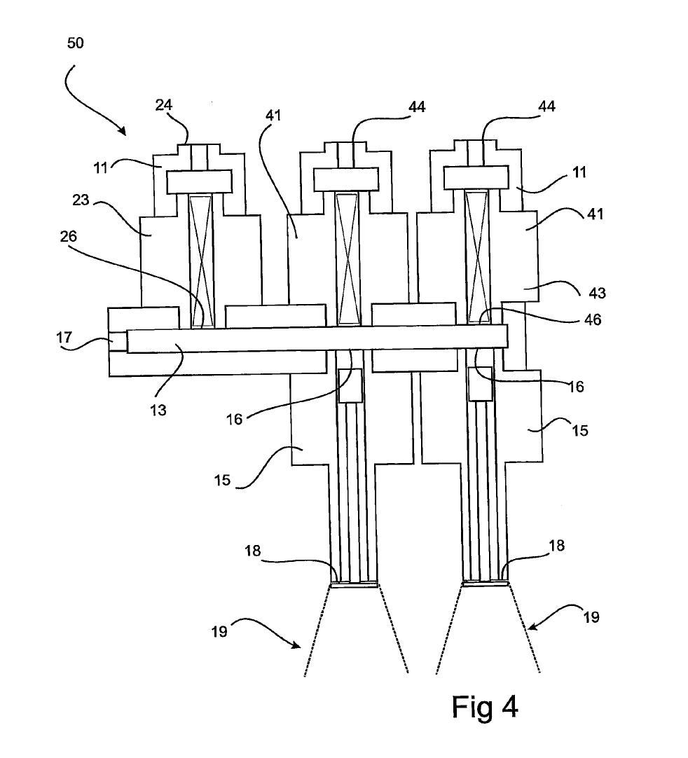

The fuel injection system 50 according to the fourth embodiment, which is shown in FIG. 4, is similar to the injection system 40 according to the third embodiment and the same reference numerals are used to identify corresponding parts. In the arrangement shown, there are two metering injectors 43 for delivery of metered quantities of the liquid fuel to the holding chamber 13, and also two delivery injectors 15 for delivery of metered quantities of the contents of the holding chamber 15 into two combustion chambers. It will, of course, be understood that the injection system 50 may be configured to incorporate more than two metering injectors 43, and also more than two delivery injectors 15.

From the foregoing, it is evident that the present invention may provide an arrangement in which air can be mixed in varying proportions with a gaseous fuel to increase the bulk of the fuel/gas mixture to facilitate metering accuracy through a fuel or delivery injector. Further, the present invention may provide an arrangement in which a gaseous fuel may be used instead of air to assist delivery of a liquid fuel. Still further, the present invention may provide an arrangement in which there is mixing of two gaseous substances, one of which is a fuel, before a further subsequent injection into an engine (which may or may not be combined with liquid fuel injection).

It should be appreciated that the scope of the invention is not limited to the scope of the various embodiments described.

In particular, the invention is not limited to an arrangement as described in the embodiments where the supplementary fluid comprises air. The supplementary fluid may, for example, comprise an oxidant other than air. Further, the supplementary fluid may comprise a fluid which when mixed with the gaseous fluid merely contributes volume to the mixture and does not function to provide an ignitable mixture.

Throughout the specification and claims, unless the context requires otherwise, the word “comprise” or variations such as “comprises” or “comprising”, will be understood to imply the inclusion of a stated integer or group of integers but not the exclusion of any other integer or group of integers.

1. A method for injecting gaseous fuel directly into a combustion chamber of an internal combustion engine using a delivery injector having a dynamic range within which it is operable to provide reliable injection, the method comprising providing a supply of gaseous fuel, delivering a metered quantity of a supplementary gaseous fluid to the gaseous fuel to form a fluid mixture of an amount commensurate with operation of the fuel injector within its dynamic range, and operating the delivery injector within the dynamic range thereof to inject a metered quantity of the fluid mixture into the combustion chamber to thereby maintain the metering accuracy of the delivery injector.

2. The method according to claim 1 wherein the supplementary gaseous fluid functions as a diluent for the gaseous fuel.

3. The method according to claim 2 wherein the supplementary gaseous fluid comprises an inactive gas which merely contributes volume to the mixture and performs no active function

4. The method according to claim 2 wherein the supplementary gaseous fluid performs an active function within the mixture.

5. The method according to claim 4 wherein the supplementary gaseous fluid comprises an oxidant.

6. The method according to claim 1 wherein gaseous fuel incorporated in the injected mixture comprises the sole fuel requirement for the combustion process.

7. The method according to claim 1 wherein the gaseous fuel incorporated in the injected mixture augments, or is augmented by, another fuel delivered into the combustion chamber for the combustion process.

8. The method according to claim 7 wherein the other fuel comprises a gaseous fuel.

9. The method according to claim 8 wherein the other fuel comprises the same type of fuel as the gaseous fuel in the injected mixture.

10. The method according to claim 7 wherein the other fuel comprises a liquid fuel.

11. The method according to claim 10 wherein the other fuel is delivered into the combustion chamber in the same injection event as the gaseous mixture.

12. A method for fuelling a combustion chamber comprising delivering a first fuel and a second fuel to a combustion chamber of an internal combustion engine using a delivery injector having a dynamic range within which it is operable to provide reliable injection, the first fuel comprising a gaseous fuel contained in a fluid mixture injected directly into the combustion chamber, the fluid mixture being of an amount commensurate with operation of the delivery injector within its dynamic range to thereby maintain the metering accuracy of the delivery injector.

13. The method according to claim 12 wherein the fluid mixture is formed by providing a supply of the gaseous fuel and delivering a metered quantity of a supplementary gaseous fluid to the gaseous fuel.

14. The method according to claim 12 wherein the fluid mixture comprises an ignitable mixture of the first fuel and an oxidant.

15. The method according to claim 12 wherein the second fuel mixes with combustion air delivered to the combustion chamber to provide a bulk lean mixture within the combustion chamber.

16. The method according to claim 15 wherein the second fuel is delivered through port injection.

17. A direct injection fuel system operating in accordance with a method according to claim 1.

18. A direct injection fuel system for an engine, the injection system comprising a delivery injector having a dynamic range within which it is operable to provide reliable injection, a holding chamber, means for providing a supply of gaseous fuel, means for delivering a metered quantity of a supplementary gaseous fluid to the gaseous fuel to form a fluid mixture of an amount commensurate with operation of the delivery injector within its dynamic range, wherein the delivery injector is operable within the dynamic range thereof for injecting a metered quantity of the fluid mixture into a combustion chamber of the engine.

19. A direct injection fuel system for an engine, the injection system comprising a delivery injector having a dynamic range within which it is operable to provide reliable injection, a holding chamber, means for providing a supply of gaseous fuel to the holding chamber, means for delivering a metered quantity of a supplementary gaseous fluid to the holding chamber, the delivery injector being operable within the dynamic range thereof for injecting a metered quantity of the contents of the holding chamber into a combustion chamber of the engine, wherein the contents of the holding chamber are of an amount commensurate with operation of the delivery injector within its dynamic range to thereby maintain the metering accuracy of the delivery injector.

20. The direct injection fuel system according to claim 19 further comprising means for delivering a metered quantity of a liquid fuel to the holding chamber.

21. A direct injection fuel system for an engine, the injection system comprising a delivery injector having a dynamic range within which it is operable to provide reliable injection, the delivery injector being operable to deliver a metered quantity of a gaseous fluid mixture comprising a first fuel and a supplementary gas to a combustion chamber, the first fuel comprising a gaseous fuel, the gaseous fuel mixture being of an amount commensurate with operation of the delivery injector within its dynamic range to thereby maintain the metering accuracy of the delivery injector, and means for delivering a second fuel to the combustion chamber.

22. An engine having a fuel injection system, the injection system comprising a delivery injector having a dynamic range within which it is operable to provide reliable injection, a holding chamber, means for providing a supply of gaseous fuel, means for delivering a metered quantity of a supplementary gaseous fluid to the gaseous fuel to form a fluid mixture of an amount commensurate with operation of the delivery injector within its dynamic range, wherein the delivery injector is operable within the dynamic range thereof for injecting a metered quantity of the fluid mixture into a combustion chamber of the engine.

23. A method for injecting gaseous fuel directly into a combustion chamber of an internal combustion engine using a delivery injector having a dynamic range within which it is operable to provide reliable injection, the method comprising providing a continuous supply of gaseous fuel, selectively delivering a metered quantity of a supplementary gaseous fluid to mix with the gaseous fuel to periodically form a fluid mixture in an amount commensurate with operation of the fuel injector within its dynamic range, and operating the delivery injector within the dynamic range thereof to inject a metered quantity of the fluid mixture into the combustion chamber to thereby maintain the metering accuracy of the delivery injector.

24. A method for injecting gaseous fuel directly into a combustion chamber of an internal combustion engine using a delivery injector having a dynamic range within which it is operable to provide reliable injection, the method comprising providing a continuous supply of gaseous fuel to a holding chamber, selectively delivering a metered quantity of a supplementary gaseous fluid to the holding chamber to mix with the gaseous fuel to periodically form a fluid mixture in an amount commensurate with operation of the fuel injector within its dynamic range, and operating the delivery injector within the dynamic range thereof to inject a metered quantity of the fluid mixture into the combustion chamber to thereby maintain the metering accuracy of the delivery injector.

25. A direct injection fuel system operating in accordance with a method according to claim 23.

26. A direct injection fuel system for an engine, the injection system comprising a delivery injector having a dynamic range within which it is operable to provide reliable injection, a holding chamber, means for continuously providing a supply of gaseous fuel, means for selectively delivering a metered quantity of a supplementary gaseous fluid to the gaseous fuel to mix with the gaseous fuel to periodically form a fluid mixture in an amount commensurate with operation of the delivery injector within its dynamic range, wherein the delivery injector is operable within the dynamic range thereof for injecting a metered quantity of the fluid mixture into a combustion chamber of the engine.

27. A direct injection fuel system for an engine, the injection system comprising a delivery injector having a dynamic range within which it is operable to provide reliable injection, a holding chamber, means for providing a continuous supply of gaseous fuel to the holding chamber, means for selectively and periodically delivering a metered quantity of a supplementary gaseous fluid to the holding chamber, the delivery injector being operable within the dynamic range thereof for injecting a metered quantity of the contents of the holding chamber into a combustion chamber of the engine, wherein the contents of the holding chamber are of an amount commensurate with operation of the delivery injector within its dynamic range to thereby maintain the metering accuracy of the delivery injector.

28. An engine having a fuel injection system, the injection system comprising a delivery injector having a dynamic range within which it is operable to provide reliable injection, a holding chamber, means for continuously providing a supply of gaseous fuel, means for selectively delivering a metered quantity of a supplementary gaseous fluid to the gaseous fuel to mix with the gaseous fuel to periodically form a fluid mixture in an amount commensurate with operation of the delivery injector within its dynamic range, wherein the delivery injector is operable within the dynamic range thereof for injecting a metered quantity of the fluid mixture into a combustion chamber of the engine.

29. (canceled)

30. (canceled)

31. (canceled)

32. A direct injection fuel system operating in accordance with a method according to claim 12.

33. An engine having a fuel injection system, the injection system comprising a delivery injector having a dynamic range within which it is operable to provide reliable injection, a holding chamber, means for providing a supply of gaseous fuel to the holding chamber, means for delivering a metered quantity of a supplementary gaseous fluid to the holding chamber, the delivery injector being operable within the dynamic range thereof for injecting a metered quantity of the contents of the holding chamber into a combustion chamber of the engine, wherein the contents of the holding chamber are of an amount commensurate with operation of the delivery injector within its dynamic range to thereby maintain the metering accuracy of the delivery injector.

34. An engine having a fuel injection system, the injection system comprising a delivery injector having a dynamic range within which it is operable to provide reliable injection, the delivery injector being operable to deliver a metered quantity of a gaseous fluid mixture comprising a first fuel and a supplementary gas to a combustion chamber, the first fuel comprising a gaseous fuel, the gaseous fuel mixture being of an amount commensurate with operation of the delivery injector within its dynamic range to thereby maintain the metering accuracy of the delivery injector, and means for delivering a second fuel to the combustion chamber.

35. A direct injection system operating in accordance with a method according to claim 24.

36. An engine having a fuel injection system, the injection system comprising a delivery injector having a dynamic range within which it is operable to provide reliable injection, a holding chamber, means for providing a continuous supply of gaseous fuel to the holding chamber, means for selectively and periodically delivering a metered quantity of a supplementary gaseous fluid to the holding chamber, the delivery injector being operable within the dynamic range thereof for injecting a metered quantity of the contents of the holding chamber into a combustion chamber of the engine, wherein the contents of the holding chamber are of an amount commensurate with operation of the delivery injector within its dynamic range to thereby maintain the metering accuracy of the delivery injector.
